(19) United States
(12) Patent Application Publication
(10) Pub. No.: US 2025/0159776 A1
(43) Pub. Date: May 15, 2025

(54) A CONTROL DEVICE FOR OF POWER SHARING BETWEEN AT LEAST TWO LIGHTING DEVICES AND A METHOD THEREOF

(71) Applicant: SIGNIFY HOLDING B.V., EINDHOVEN (NL)

(72) Inventors: SHUAIB AHMED, DELHI (IN); MANOJ KUMAR, MEERUT (UP) (IN); ATUL KAUSHIK, GURUGRAM (IN); DEBASISH MUKHERJEE, NEW DELHI (IN)

(21) Appl. No.: 18/726,894

(22) PCT Filed: Dec. 13, 2022
(86) PCT No.: PCT/EP2022/085606

§ 371 Date: Jul. 5, 2024

(30) Foreign Application Priority Data
Jan. 7, 2022 (IN) 202241000973
Feb. 17, 2022 (EP) 22157171.4

(51) Int. Cl. H05B 47/115

(52) U.S. Cl. CPC H05B 47/115

(57) ABSTRACT

A method of power sharing between at least two lighting devices located in an outdoor environment, wherein each of the at least two lighting devices comprises an energy storage element arranged for providing power to the respective at least two lighting devices; and wherein the at least two lighting devices are connected to each other via an electric conductor; wherein the method comprises determining a state of charge, SoC, and/or voltage of the energy storage elements of the at least two lighting devices, controlling a first lighting device of the at least two lighting devices to operate in an up-stream mode if the SoC and/or voltage of the respective energy storage element exceeds a threshold, and controlling a second lighting device of the at least two lighting devices to operate in a down-stream mode if the SoC and/or voltage of the respective energy storage element does not exceed the threshold, wherein the second lighting device is arranged for communicating the operating mode to at least one lighting device of the at least two lighting devices, inferring an occupancy pattern in proximity of each of the at least two lighting devices based on historical occupancy data; and if the first lighting device have been detected to be operating in an up-stream mode, sharing power, via the electric conductor, from the first lighting device to the second lighting device based on the inferred occupancy.

### FIELD OF THE INVENTION

The invention relates to a method of power sharing between at least two lighting devices located in an outdoor environment. The invention further relates to a control device, a system, and a computer program product for power sharing between at least two lighting devices located in an outdoor environment.

### BACKGROUND

Streetlights does not only increase the aesthetics of a city, but they are also necessary to increase safety and security for the locals at evening or night. They also help auto vehicles such as cars, trucks etc. to safely navigate within and outside the city. Therefore, reliability of such streetlights is of high concern. Streetlights should provide sufficient illumination during dusk to dawn. Any disruption of power which results in a blackout of any of the streetlights can potentially cause threat to safety and security.

With the recent focus on green energy, sustainable power sources such as solar energy are gaining a lot of attention. Since streetlights are exposed to sun during the daytime, they become an ideal candidate to be powered via solar energy. Although, solar powered streetlights bring advantages over conventional AC powered streetlights but also leads to load reliability issues due to limitations of battery capacity, sun insolation during the day, damages to solar power source etc. Such limitations may result in power fluctuations or in worst case blackout during night times. One of the typical solutions to prevent blackout for battery powered streetlights is to increase battery capacity or increase solar power photovoltaic cell (PV) size.

### SUMMARY OF THE INVENTION

Inventors have realized that increasing size of battery and/or solar power photovoltaic cell (PV) will not only make the system bulky but also costly. Furthermore, increasing battery or PV size will not be able to resolve the problem completely. It is an object of the present invention to address the problems as stated above and additional (related) problems. Therefore, a method, a system, a control device, and a computer program product are provided to increase load reliability without increasing the energy storage or solar power photovoltaic cell size. According to a further object of the invention, the cost of the system is also reduced.

According to a first aspect, the object is achieved by a method of power sharing between at least two lighting devices located in an outdoor environment, wherein each of the at least two lighting devices comprises an energy storage element arranged for providing power to the respective at least two lighting devices; and wherein the at least two lighting devices are connected to each other via an electric conductor; wherein the method comprises determining a state of charge, SoC, and/or voltage of the energy storage elements of the at least two lighting devices, controlling a first lighting device of the at least two lighting devices to operate in an up-stream mode if the SoC and/or voltage of the respective energy storage element exceeds a threshold, and controlling a second lighting device of the at least two lighting devices to operate in a down-stream mode if the SoC and/or voltage of the respective energy storage element does not exceed the threshold, wherein the second lighting device is arranged for communicating the operating mode to at least one lighting device of the at least two lighting devices, inferring an occupancy pattern in proximity of each of the at least two lighting devices based on historical occupancy data; and if the first lighting device have been detected to be operating in an up-stream mode, sharing power, via the electric conductor, from the first lighting device to the second lighting device based on the inferred occupancy.

The method is related to power sharing between at least two lighting devices. The number of lighting devices may be more than 2, e.g., 5, 10 etc. The lighting devices are located in an outdoor environment, such as streets, stadiums etc. For example, the lighting devices are streetlights, stadium lights etc. Any other outdoor environment and the lighting devices used in that environment are not excluded. The power transfer or sharing is from a device or a plurality of devices to a single device or a plurality of devices.

Each of the at least two lighting devices comprises an energy storage element arranged for providing power to the respective at least two lighting devices. The energy storage element may be a rechargeable battery such as a Lithium Iron Phosphate (LFP) battery, a Lithium-Ion battery or a Nickel-based battery, wherein the plurality of energy storage units may comprise individual battery cells. The energy storage element may be a capacitor, or any other element arranged for storage electrical energy. The lighting devices may be arranged for receiving power from the energy storage element to power a load of the lighting devices, e.g., a lamp which is used to illuminate the outdoor environment. The capacity of the energy storage element is chosen, e.g., based on the load. In an example, each devices comprises a different type/size of energy storage element, e.g., based on the load requirements of the respective lighting device.

The at least two lighting devices are connected to each other via an electric conductor. An electrical conductor is a substance in which electrical charge carriers, usually electrons, move easily from atom to atom with the application of voltage. The electric conductor may be used to share power between the lighting devices. In an example, the electric conductor transfer DC power or AC power. In another example, the electric conductor may be used to communicate between the at least two lighting devices.

The method comprises determining a state of charge, SoC, and/or voltage of (each of) the energy storage elements of the at least two lighting devices. For example, the state-of-charge may be estimated based on a measurement of voltage and current of the energy storage units. In an example, after installation of an energy storage element, the SoC is estimated based on energy storage element terminal voltage. Once energy storage element is full discharged or full charged SOC to determine by integrating net current flowing to or from the energy storage element for a particular amount of time. The voltage may be measured across the energy storage element terminals. The determination may be performed for each of the energy storage element of the at least two lighting devices. Any other method for determining a state of charge, SoC, and/or voltage of (each of) the energy storage elements of the at least two lighting devices is not excluded.

The at least two lighting devices may be arranged to operate in an up-stream or a down-stream operating mode. The operation mode may comprise a phase of operation during the operation of the life cycle of the lighting devices. The method comprises controlling a first lighting device of the at least two lighting devices to operate in an up-stream mode if the SoC and/or voltage of the respective energy storage element exceeds a threshold. The first lighting device may be a single device or a plurality of devices. It should be understood and clear to a skilled person in the field of electrical power that different thresholds may be defined separately for SoC and voltage, i.e., a SoC threshold defined for SoC, and a voltage threshold defined for voltage.

The method further comprises controlling a second lighting device of the at least two lighting devices to operate in a down-stream mode if the SoC and/or voltage of the respective energy storage element does not exceed the threshold. The second lighting device may be a single device or a plurality of devices. The threshold may be defined e.g., based on the capacity of the energy storage element. In an extreme example, there may be no devices which is operating in the up-stream mode such that all the devices are operating in the down-stream mode in a given time window. Alternatively, there may be no devices operating in a down-stream mode such that all the devices are operating in an up-stream mode. The first device is any device from the at least two lighting devices operating in the up-stream mode and the second device is any device from the at least lighting devices operating in the down-stream mode.

The second lighting device or any device which is operating in a down-stream mode may be arranged for communicating the operating mode to at least one lighting device of the at least two lighting devices. The down-stream device or the second device may communicate the operating mode to other devices of the at least two devices, e.g., it raises a power request that it is operating in the down-stream mode. The status may be communicated irrespective of the receiving devices are operating in the up-stream mode or the down-stream mode. Alternatively, the status may be communicated to only up-stream devices if any. In an example, the second device or any device which is operating in a down-stream mode may not know the operating mode of the other devices. The second device or any device which is operating in a down-stream mode may have a wired or wireless communication link with the other devices of the at least two devices to communicate the status. The communication link can be a direct link between the at least two lighting devices or a link via a third external device e.g., via server, cloud etc. In an example, all devices share their operating mode, such that up-stream devices may also communicate their operating mode with (all other) devices.

In an example, the first lighting device of the at least two lighting devices is controlled to operate in an up-stream mode if the SoC and/or voltage of the respective energy storage element exceeds a threshold, and if the first lighting device has received an request from a down-stream lighting device. If no request has been received, the first lighting device may be controlled to operate in an idle mode.

The method comprises inferring an occupancy pattern in proximity of each of the at least two lighting devices based on historical occupancy data. The proximity may comprise an area of field of view of the lighting device. The occupancy pattern may be inferred from a trained machine/model which has been trained based on historical occupancy data. Machine learning may be used for such training, e.g., supervised learning may be used. The algorithm(s) for training a model is well-known in the art of machine learning and hence not further discussed here. The inferring may be performed at the lighting devices, or external to the lighting devices such as at the cloud/server and then communicated to the lighting devices. The occupancy pattern may comprise a knowledge of the occupancy in the field of view of the lighting device. The inferred occupancy may be for the time between dusk to dawn. The historical occupancy data may comprise previous occupancy in the field of view of the lighting device.

In a preferred example, the lighting devices are standalone devices, e.g., the lighting devices are connectionless devices with no connection to an external third device which is not from the at least two lighting devices for instance cloud/server. In this example, the training of the machine/model may have been performed at the third external device and the trained machine/model is then deployed at the lighting devices. In another example, at least one of the at least two devices may comprise a connection with the internet/cloud/server.

Since the method further comprise if the first lighting device have been detected to be operating in an up-stream mode, sharing power, via the electric conductor, from the first lighting device to the second lighting device based on the inferred occupancy, the inferred occupancy is taken account for power sharing and thus provides load reliability (prevents blackout conditions) without increasing the size of energy storage elements.

In an embodiment, the inferring the occupancy pattern may be further based on one or more of: season of the year, time from dusk to dawn, geographical location of the at least two lighting devices.

In addition to inferring occupancy pattern based on historical occupancy data, the inferring may be further based on season of the year, e.g., it is expected to be less crowded in winter compared to summer. Similarly, rain reason and dry season may also influence inferred occupancy. The inferring may be further based on time from dusk to dawn, e.g., the occupancy is expected to be lesser as the night progresses. The inferring may be further based on geographical location of the at least two lighting devices, e.g., the outdoor lighting device in proximity to a restaurant, bar expects more people compared to a lighting device which is located at an isolated place. Therefore, by considering one or more of these factors for inferring occupancy, the reliability of the system is further improved.

In an embodiment, the electrical conductor may be an ethernet cable, and wherein the second lighting device may be arranged for communicating the operating mode to the at least one lighting device of the at least two lighting devices via the ethernet cable.

In an advantageous embodiment, the electrical conductor may be an ethernet cable. In a further advantageous embodiment, the communication between the at least two lighting devices may be based on Power-over-Ethernet protocol such that both the data e.g., communication of the operating mode, and power are transferred via the ethernet cable. The communication/power transfer via ethernet cable may follow any of the current or future PoE standard, e.g., IEEE 802.3af, IEEE 802.3at, IEEE 802.3bt.

In an embodiment, the method may further comprise selecting a nearest lighting device from the at least two lighting devices which is nearest in distance from the second lighting device, wherein the second lighting device may be arranged for communicating the operating mode to the selected nearest lighting device.

In this advantageous embodiment, the communication of the down-stream mode may preferably be made to devices which are close to the lighting device operating in the down-stream mode. The nearest in distance refers to the device which is closest in terms of physical distance to the lighting device operating in the down-stream mode compared to other lighting devices which are far in distance. The lighting device operating in the down-stream mode may have the knowledge of a map comprising location of all lighting devices w.r.t its own physical location, or maybe have the knowledge of its neighbors or at least nearest neighbor. Alternatively, if the device is equipped with wireless communication, it may send a single hop message, which is only received by the nearest neighbors. If the device is equipped with wired communication, the device may get potential neighbors estimation based on latency of response, and/or the device may demand power from all up-stream lighting devices one by one & finally settles to one from which it is getting max power.

In an embodiment, each of the at least two lighting devices may comprise a bi-directional up-down energy storage element driver arranged for charging/discharging the energy storage element, and wherein the up-down energy storage element driver may be arranged for discharging the energy storage element by transferring power from the energy storage element in the up-stream mode; and may be further arranged for charging the energy storage element from received power, via the electric conductor, in the down-stream mode.

Since each of the at least two lighting devices supports up and down-stream operating mode, the at least two lighting devices advantageously comprise a bi-directional up-down energy storage element driver arranged for charging/discharging the energy storage elements of the respective lighting device. The driver allows a bi-directional flow of current to/from the energy storage element. For example, the up-down energy storage element driver may be arranged for discharging the energy storage element by transferring power from the energy storage element in the up-stream mode; and may be further arranged for charging the energy storage element from received power, via the electric conductor, in the down-stream mode. The power transfer in up-stream mode may be used to charge the energy storage element of the receiving lighting device (down-stream device) and/or (directly) power the load. For example, for the case of streetlights, the load may be powered directly during the evening/nighttime (without energy storage element charging) and/or the energy storage element may be charged during the daytime (when there is no need for the streetlights to illuminate). The up-stream lighting device may have already fully charged energy storage element.

In an embodiment, the method may further comprise inferring the SoC and/or voltage of the at least two lighting devices based on one or more of: season of the year, time of the day, geographical location of the at least two lighting devices; wherein the method may further comprise sharing power between the at least two based on inferred SoC and/or voltage of the at least two lighting devices.

In this advantageous embodiment, the power sharing is also based on inferred SoC and/or voltage of the energy storage elements. This will further improve the reliability and reduces the chances of blackout.

In an embodiment, the method may further comprise detecting if there is no (first) lighting device from the least two lighting devices operating in an up-stream mode, controlling the nearest lighting device from the at least two lighting devices such that the power consumption of the nearest lighting device is reduced to share power from the first lighting device to the second lighting device.

In some cases, there is a possibility that no lighting devices from the at least two lighting devices may be operating in the up-stream mode and be able to provide power. In this worst scenario, the nearest lighting device to the down-stream lighting device may be controlled to reduce its power consumption, e.g., by dimming the lighting load. Such dimming will save power and the saved power can be transmitted to the down-stream lighting device. In this example, a simple way for detection may be to wait for the power from other devices and if no power is received within a time period, then it may be concluded that no lighting device from the at least two lighting devices is operating in the up-stream mode and cannot provide/share power. In an alternative example, lighting devices away from the nearest may also be controlled.

In an embodiment, the at least two lighting devices may be further arranged to receive power via AC mains. In an embodiment, the energy storage elements of at least two lighting devices may be powered via a solar power source.

In these embodiments, the at least two lighting devices may be powered via AC means. Additionally, and/or alternatively, the energy storage elements may be powered via the solar power source, e.g., via the PV cells. In another example, it can be a hybrid system, wherein both AC and/or solar power source is used to charge the battery.

In an embodiment, the method may further comprise determining SoC and/or voltage of the at least two lighting devices over time, and if the SoC and/or voltage of the at least two lighting devices over time does not exceed a capacity threshold for the energy storage elements of the respectively lighting devices, controlling the (respective) lighting device to operate in a down-stream mode.

The issue of blackout may also be caused by a broken/damage/dirty or not fully functional power source to charge the electrical energy storage element. In this example, the SoC and/or voltage of the at least two lighting devices may be determined over time, e.g., to determine if the charging is performed according to the expected charging. If there is any anomaly, e.g., if the SoC and/or voltage of the at least two lighting devices over time does not exceed a capacity threshold for the energy storage elements of the respectively lighting devices, the respective lighting devices(s) may be controlled to operate in a down-stream mode. The capacity threshold may be defined based on type, capacity of the energy storage element.

In an embodiment, controlling the at least two lighting devices to operate in the up-stream mode and/or the down-stream mode may be further based on one or more of: health of the energy storage element, health of the solar power source, remaining back up power in the energy storage element till dawn time.

In this example, the method may further comprise detecting health of the energy storage element, health of the solar power source, remaining back up power in the energy storage element till dawn time. Additionally, and/or alternatively, this information may be received from an external device. Based on health of the energy storage element, health of the solar power source, remaining back up power in the energy storage element till dawn time, the at least lighting devices may be controlled to operate either in the up-stream mode or the down-stream mode. The term ‘health’ relates to functional behavior of the device, such that devices not functioning properly is not considered healthy.

In an embodiment, the at least two lighting devices at least may not comprise occupancy sensor. The (each of) at least lighting devices may not comprise any occupancy sensor, e.g., the occupancy information is only inferred based on the historical occupancy pattern.

According to a second aspect, the object is achieved by a control device for power sharing between at least two lighting devices located in an outdoor environment, wherein the control device comprises a processor arranged for executing and/or controlling at least some of the steps of method according to the first aspect.

According to a third aspect, the object is achieved by a system for power sharing between at least two lighting devices located in an outdoor environment, wherein the system comprises: at least two lighting devices located in an outdoor environment, and a control device according to the second aspect.

According to a fourth aspect, the object is achieved by a computer program product comprising instructions which, when the program is executed by a computer, cause the computer to carry out the steps of the method of the first aspect.

It should be understood that the computer program product, the control device, and the system may have similar and/or identical embodiments and advantages as the above-mentioned methods.

### BRIEF DESCRIPTION OF THE DRAWINGS

The above, as well as additional objects, features and advantages of the disclosed systems, devices and methods will be better understood through the following illustrative and non-limiting detailed description of embodiments of systems, devices and methods, with reference to the appended drawings, in which:

FIG. 1 shows schematically and exemplary an embodiment of a system for power sharing between at least two lighting devices;

FIG. 2 shows schematically and exemplary an embodiment of a lighting device for power sharing between at least two lighting devices;

FIG. 3 shows schematically and exemplary a flowchart illustrating an embodiment of a method for power sharing between at least two lighting devices.

All the figures are schematic, not necessarily to scale, and generally only show parts which are necessary in order to elucidate the invention, wherein other parts may be omitted or merely suggested.

### DETAILED DESCRIPTION OF EMBODIMENTS

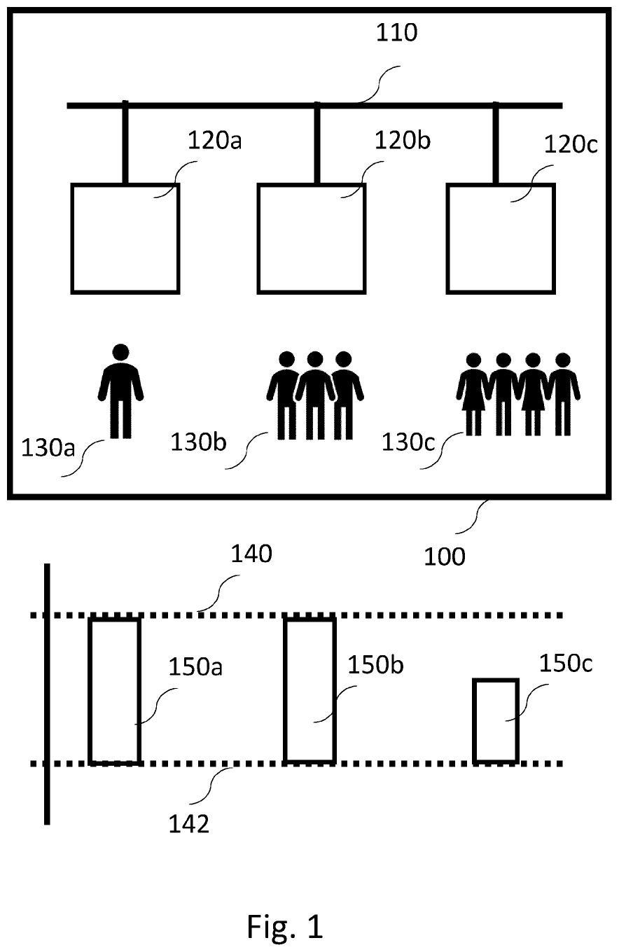

FIG. 1 shows schematically and exemplary an embodiment of a system 100 for power sharing between at least two lighting devices 120a-c. The lighting devices 120a-c may comprise streetlights. In this exemplary figure, only three lighting devices 120a-c are shown. The lighting devices 120a-c may be of any number such as 3, 5, 10, 100 etc. A lighting device is a device or structure arranged to emit light suitable for illuminating an environment, providing or substantially contributing to the illumination on a scale adequate for that purpose. The environment may comprise an outdoor environment, such as streets, highways etc. In an example, one of or each of the lighting devices 120a-c may different configurations such as different size of energy storage element, different solar power source cell size (not shown), different load, and different pole height etc. For instance, a high mast is installed at the road crossing with large solar power source cell, energy storage element and load. The power requirement of this mast is different than other normal streetlight at different time. Some devices can be underutilized, and some can be over utilized. In another example, all lighting devices 120a-c have same configurations.

The system 100 comprises an electric conductor 110. In an example, the electrical conductor 110 is an ethernet cable. In an example, the at least two lighting devices 120a-c is arranged for communicating and sharing power via the same ethernet cable, e.g., via using any of the standard of Power-over-Ethernet (POE). In an alternative example, communication and power sharing are performed via (e.g., RS485) power line communication (e.g., PoRS485). In an example, the electric conductor 110 is a DC bus. In another example, the electric conductor 110 is a power bar. In an example, the electric conductor 110 comprises two different conductors, wherein one of the two conductors is arranged for data transfer and the other is arranged for power sharing. Any other wired communication is not excluded. In another example, the communication is based on a wireless communication protocol, e.g., Zigbee, Bluetooth, Thread etc.

An occupancy in proximity of the at least two lighting devices 120a-c are shown exemplary as 130a-c. In an example, not all the lighting devices experience same occupancy, e.g., the occupancy may be based on season of the year, time from dusk to dawn, geographical location of the at least two lighting devices. In the figure, the lighting device 120a-c is experiencing higher occupancy and thus needs to illuminate, e.g., at 100% brightness level for a longer time. The lighting device 120a-c may have an occupancy sensor. In an alternative example, the lighting device 120a-c may be an occupancy sensor less lighting device 120a-c. In another example, at least one of the at least two lighting devices 120a-c may have an occupancy sensor.

FIG. 1 also exemplary shows the backup energy 150a-c available in the energy storage element (not shown in FIG. 1) for each the at least two lighting devices 120a-c. The backup energy 150a-c is shown from dusk 142 to dawn 140. Streetlights should provide illumination, irrespective of occupancy, from dusk to dawn. If a higher occupancy is inferred, then a higher amount of energy may be consumed compared to available backup energy 150a-c, and thus it will be not sufficient to power the lighting device 120-a-c till dawn. In the exemplary figure, lighting device 120c experiences higher occupancy, therefore, it cannot dim down its load (e.g., lower brightness) and as a result the backup energy 150c available for the lighting device 150c is not sufficient for till dawn 140.

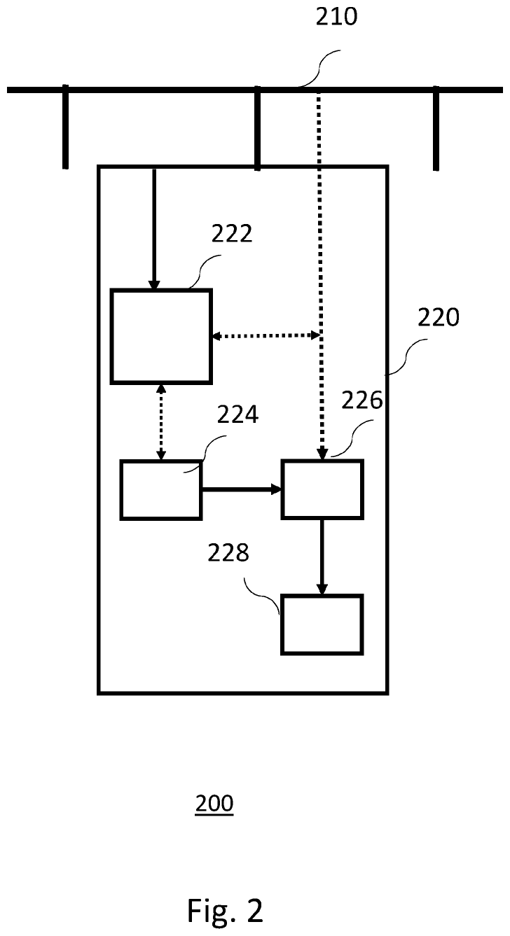

FIG. 2 shows schematically and exemplary an embodiment of a lighting device 220 for power sharing between at least two lighting devices 120a-c. The lighting device 220 comprises an energy storage element 224 arranged for providing power to the lighting device 220. The lighting device 220 is arranged for operating in an up-stream mode or a down-stream mode. In the up-stream mode, the lighting device 220 is arranged for transferring power to another lighting device 120a-c (e.g., the nearest lighting device). In the down-stream mode, the lighting device 220 is arranged for receiving power from other lighting devices 210. In the down-stream mode, the lighting device 220 is further arranged for communicating its operating mode to other lighting devices 220 or at least to one or more of the nearest lighting device(s). The sharing of power is performed via the electric conductor 210.

The lighting device 220 comprises a bi-directional up-down energy storage element driver 222 arranged for charging/discharging the energy storage element 224, and wherein the up-down energy storage element driver 222 may be arranged for discharging the energy storage element 224 by transferring power from the energy storage element 224 in the up-stream mode; and is further arranged for charging the energy storage element 224 from received power, via the electric conductor 210, in the down-stream mode. The bi-direction driver 222 allows a bidirectional flow of current. The bi-direction driver 222 may comprise a topology of a synchronous buck/boost converter for the down-stream and up-stream lighting devices respectively. The up or down drive mode can be selected and controlled by duty cycle (PWMs) of the high side and lower side MOSFETs.

The lighting device 220 further comprises a load 228. For example, the load may comprise at least one light source or lamp, such as an LED-based lamp, gas-discharge lamp or filament bulb, etc. The lighting device 220 may comprise a load driver 226 which is arranged for driving the load, e.g., converting the received power to a power suitable for the load 228.

In the exemplary figure, the dotted line shows the power received via the other lighting device 220. In an example, the received power may be used to charge the energy storage element 224 via the up-down energy storage element driver 222 and/or may be used to (directly) power the load 228 via the load driver 226. In the example, the received power may be used to charge the energy storage element 224 in the daytime, and/or the received power may be used to (directly) power the load 228 at evening or nighttime. For instance, the occupancy is inferred for the evening/night, e.g., from dusk to dawn for a particular lighting device 220, and if it indicates a higher occupancy compared to the backup energy 150a-c available in energy storage element 224 of the lighting device 220, the lighting device 220 may change its operating mode to a down-stream mode and requests power from nearby lighting devices 220.

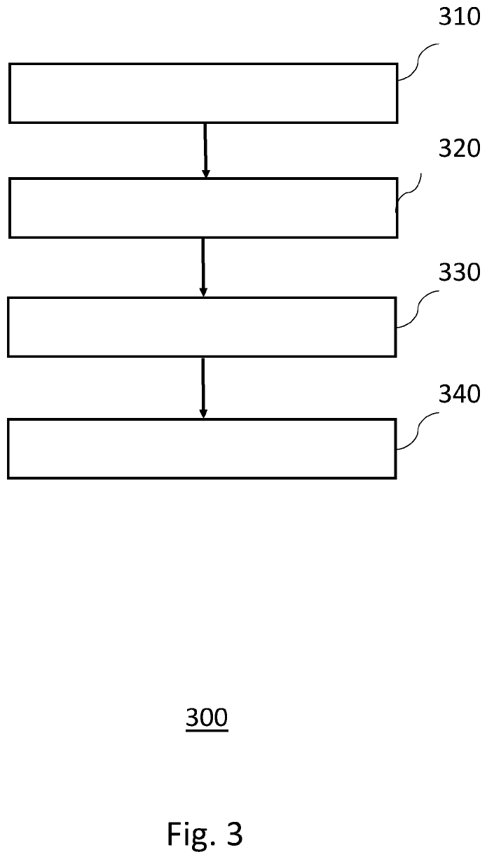

FIG. 3 shows schematically and exemplary a flowchart illustrating an embodiment of a method 300 for power sharing between at least two lighting devices 120a-c, 220 located in an outdoor environment. Each of the at least two lighting devices 120a-c, 220 comprises an energy storage element 224 arranged for providing power to the respective at least two lighting devices 120a-c, 220; and wherein the at least two lighting devices 120a-c, 220 are connected to each other via an electric conductor 110, 210.

The method 300 comprises determining 300 a state of charge, SoC, and/or voltage of the energy storage elements of the at least two lighting devices. State of charge (SoC) is the level of charge of an energy storage element 224 relative to its capacity. The units of SoC are percentage points (0%=empty; 100%=full).

The method 300 further comprises controlling 320 a first lighting device 120a-c, 220 of the at least two lighting devices 120a-c, 220 to operate in an up-stream mode if the SoC and/or voltage of the respective energy storage element 224 exceeds a threshold, and controlling 320 a second lighting device 120a-c, 220 of the at least two lighting devices 120a-c, 220 to operate in a down-stream mode if the SoC and/or voltage of the respective energy storage element does not exceed the threshold.

The second lighting device 120a-c, 220 or the down-stream lighting device 120a-c, 220 is arranged for communicating the operating mode to at least one lighting device 120a-c, 220 of the at least two lighting devices 120a-c, 220. In an example, since communication to lighting devices far from the down-stream lighting device 120a-c, 220 may not be advantageous (e.g., because of power transfer from far distance causes high losses), a nearest lighting device 120a-c, 220 from the at least two lighting devices 120a-c, 220 may be selected which is nearest in distance from the second lighting device 120a-c, 220, wherein the second lighting device 120a-c, 220 may be arranged for communicating the operating mode (and later receiving power) to the selected nearest lighting device 120a-c, 220.

The at least two lighting devices 120a-c, 220 may be further controlled to operate in the up-stream mode and/or the down-stream mode further based on one or more of: health of the energy storage element 224, health of the solar power source, remaining back up power in the energy storage element till dawn. The health of the energy storage element 224 may be determined e.g., by SoC and/or voltage of the at least two lighting devices over time being below a capacity threshold. The health of the solar power source may also be determined directly or indirectly via the charging of the energy storage element 224. The remaining backup power is also an important aspect, e.g., if the remaining backup is not sufficient till dawn, the lighting device 120a-c, 220 may be controlled to operate in a down-stream mode. In such cases, e.g., when the energy storage element 224 is not properly charging, the improper charging may be due to broken solar power source (not shown), dirty PV cells, and/or cable losses. In the down-stream mode, the lighting device 120a-c, 220 may then receive a portion of power from solar power source and other portion from the other lighting device 120a-c, 220 in up-stream mode.

The method 300 may further comprise inferring 330 an occupancy pattern in proximity of each of the at least two lighting devices 120a-c, 220 based on historical occupancy data. In a simple example, inferring may be based on extrapolation. In other example, inferring may be based on a linear model for prediction such as least squares. In an advanced embodiment, the inferring may be based on a deep neural net such as CNN. In an example, inferring of the occupancy pattern is further based on one or more of season of the year, time from dusk to dawn, geographical location of the at least two lighting devices. For example, the occupancy is inferred for the coming evening/nighttime.

The method 300 may further comprise if the first lighting device 120a-c, 220 have been detected to be operating in an up-stream mode, sharing power 340, via the electric conductor 110,210, from the first lighting device 120a-c, 220 to the second lighting device 120a-c, 220 based on the inferred occupancy. The method 300 may comprise an optional step of detecting if the first lighting device 120a-c, 220 is operating in the up-stream mode. The detection of an up-stream device may be performed by communication between the devices or from a central device, such as a central control device.

The up-stream lighting device 120a-c, 220 may share the power with a down-stream device 120a-c, 220 based on the inferred occupancy. For example, if the inferred occupancy shows a higher occupancy for the coming night compared to the available backup power in the energy storage element 224, the lighting device 120a-c, 220 may be controlled to operate in a down-stream mode, and thus may receive power from an up-stream lighting device 120a-c, 220. The power sharing 340 may be performed in the daytime e.g., to charge the energy storage element 224 and prepare for the higher inferred occupancy, and/or directly power the load 228 at evening/nighttime. The charging of the energy storage element 224 may be performed at nighttime as well.

In a worst condition, if there is no lighting device 120a-c, 220 from the at least two lighting devices 120a-c, 220 operating in an up-stream mode, the down-stream lighting device 120a-c, 220 may e.g., issue an SOS signal or a distress signal. Based on such a condition, one of the at least two lighting devices 120a-c, 220 preferably the nearest lighting device 120a-c, 220 from the at least two lighting devices 120a-c, 220 may be then controlled such that the power consumption of the first lighting device 120a-c, 220 is reduced to share power from the nearest lighting device 120a-c, 220 to the second lighting device 120a-c, 220. If even after SOS signal, other devices are not able to share their power (e.g., communication broken) then this device can dim itself to a minimum fix level based on its SOC in order to survive the whole night

The method 300 may be executed by a control device (not shown). The control device may be implemented in a unit separate from the at least two lighting devices 120a-c, 220, such as wall panel, desktop computer terminal, or even a portable terminal such as a laptop, tablet or smartphone. Alternatively, the control device may be incorporated into the same unit as one or more of the at least two lighting devices 120a-c, 220. Further, the control device may be implemented in the outdoor environment or remote from the environment (e.g. on a server of the building or even outside the building at a different geographical site); and the control device may be implemented in a single unit or in the form of distributed functionality distributed amongst multiple separate units (e.g. a distributed server comprising multiple server units at one or more geographical sites, or a distributed control function distributed amongst the at least two lighting devices 120a-c, 220). Furthermore, the control device may be implemented in the form of software stored on a memory (comprising one or more memory devices) and arranged for execution on a processor (comprising one or more processing units), or the control device may be implemented in the form of dedicated hardware circuitry, or configurable or reconfigurable circuitry such as a PGA or FPGA, or any combination of these. The control device may comprise a processor (not shown) and a memory (not shown).

The method 300 may be executed by computer program code of a computer program product when the computer program product is run on a processing unit of a computing device, such as the processor of the control device.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A method of power sharing between at least two lighting devices located in an outdoor environment, wherein each of the at least two lighting devices comprises an energy storage element arranged for providing power to the respective at least two lighting devices; and wherein the at least two lighting devices are connected to each other via an electric conductor;
wherein the method comprises
determining a state of charge, SoC, and/or voltage of the energy storage elements of the at least two lighting devices,
controlling a first lighting device of the at least two lighting devices to operate in an up-stream mode if the SoC and/or voltage of the respective energy storage element exceeds a threshold, and controlling a second lighting device of the at least two lighting devices to operate in a down-stream mode if the SoC and/or voltage of the respective energy storage element does not exceed the threshold, wherein the second lighting device is arranged for communicating the operating mode to at least one lighting device of the at least two lighting devices,
inferring an occupancy pattern in proximity of each of the at least two lighting devices based on historical occupancy data; and
if the first lighting device have been detected to be operating in an up-stream mode, sharing power, via the electric conductor, from the first lighting device to the second lighting device based on the inferred occupancy,
wherein the energy storage elements of at least two lighting devices are powered via a solar power source.

2. The method according to claim 1, wherein the inferring the occupancy pattern is further based on one or more of:
season of the year,
time from dusk to dawn,
geographical location of the at least two lighting devices.

3. The method according to claim 1, wherein the electrical conductor is an ethernet cable, and wherein the second lighting device is arranged for communicating the operating mode to the at least one device of the at least two lighting devices via the ethernet cable.

4. The method according to claim 1, wherein the method further comprises
selecting a nearest lighting device from the at least two lighting devices which is nearest in distance from the second lighting device, wherein the second lighting device is arranged for communicating the operating mode to the selected nearest lighting device.

5. The method according to claim 1, wherein each of the at least two lighting devices comprises a bi-directional up-down energy storage element driver arranged for charging/discharging the energy storage element, and wherein the up-down energy storage element driver is arranged for discharging the energy storage element by transferring power from the energy storage element in the up-stream mode; and is further arranged for charging the energy storage element from received power, via the electric conductor, in the down-stream mode.

6. The method according to claim 1, wherein the method further comprises:
inferring the SoC and/or voltage of the at least two lighting devices based on one or more of: season of the year, time of the day, geographical location of the at least two lighting devices;
wherein the method further comprises:
sharing power between the at least two based on inferred SoC and/or voltage of the at least two lighting devices.

7. The method according to claim 1, wherein the method further comprises:
detecting if there is no lighting device from the least two lighting devices operating in an up-stream mode,
controlling the nearest lighting device from the at least two lighting devices such that the power consumption of the nearest lighting device is reduced to share power from the nearest lighting device to the second lighting device.

8. The method according to claim 1, wherein the at least two lighting devices are further arranged to receive power via AC mains.

9. The method according to claim 1, wherein the method further comprises:
determining SoC and/or voltage of the at least two lighting devices over time, and if the SoC and/or voltage of the at least two lighting devices over time does not exceed a capacity threshold for the energy storage elements of the respectively lighting devices,
controlling the lighting device to operate in a down-stream mode.

10. The method according to claim 1, wherein controlling the at least two lighting devices to operate in the up-stream mode and/or the down-stream mode is further based on one or more of: health of the energy storage element, health of the solar power source, remaining back up power in the energy storage element till dawn.

11. The method according to claim 1, wherein the at least two lighting devices at least does not comprise occupancy sensor.

12. A control device for power sharing between at least two lighting devices located in an outdoor environment, wherein the control device comprises a processor arranged for executing and/or controlling at least some of the steps of method according to claim 1.

13. A system for power sharing between at least two lighting devices located in an outdoor environment, wherein the system comprises:
at least two lighting devices located in an outdoor environment,
a control device according to claim 12.

14. A computer program product comprising instructions which, when the program is executed by a computer, cause the computer to carry out the steps of the method of claim 1.
